(19) United States
(12) Patent Application Publication
(10) Pub. No.: US 2018/0155557 A1
(43) Pub. Date: Jun. 7, 2018

(54) ABRASIVE PAINT REMOVER COMPOSITIONS AND METHODS FOR MAKING AND USING SAME

(71) Applicant: Packaging Service Co., Inc., Pearland, TX (US)

(72) Inventors: John S. Ledford, Pearland, TX (US); Lynn Place, Pearland, TX (US); Jean-Pierre Baizan, Pearland, TX (US); Mark Vorderbruggen, Pearland, TX (US)

(21) Appl. No.: 15/645,461

(22) Filed: Jul. 10, 2017

Related U.S. Application Data
(63) Continuation-in-part of application No. 15/361,380, filed on Nov. 26, 2016.

(51) Int. Cl. C09D 9/02; C09D 9/04; C09D 9/00; B08B 3/08; B08B 7/00

(52) U.S. Cl. CPC C09D 9/02; C09D 9/04; B08B 2220/01; B08B 3/08; B08B 7/0014; C09D 9/005

(57) ABSTRACT

Abrasive paint remover compositions including a solvent system or composition and an abrasive system or composition and methods for making and using same, where the compositions may be formulated with no methylene chloride (MC).

### RELATED APPLICATIONS

The present application is a continuation-in-part to U.S. patent application Ser. No. 15/361,380 filed Nov. 26, 2016 (26 Nov. 2016).

### BACKGROUND OF THE INVENTION

### 1. Field of the Invention

Embodiments of the present disclosure relate to abrasive paint remover compositions and methods for making and using same.

Embodiments of the present disclosure relate to abrasive paint remover compositions and methods for making and using same, where the compositions include a solvent composition or system and an abrasive composition or system.

### 2. Description of the Related Art

The US Department of Labor through OSHA has raised concerns about the occupational safety of methylene chloride (MC) for many types of work activities. Thus, the industry has been engaged in an ongoing effort to reduce or eliminate the use of MC in paint removers as seen in U.S. Pat. No. 6,608,012.

However, many of the non-MC removers are significantly slower in removing paint compared to traditional MC paint removers. Many solutions have been suggested such as a benzyl alcohol gel coupled with an impermeable membrane such as the membrane disclosed in U.S. Pat. No. 8,361,947. This membrane removal system may take up to 24 hours to remove stubborn paint and requires some skill to cut and apply the membrane properly.

There have been graffiti removers such as U.S. Pat. No. 5,929,005 that claim the use of “mildly abrasive” abrasive filler, designed only to remove graffiti stained surfaces without damaging the paint underneath.

Thus, there is a need in the art for a less toxic, more volatile organic compound (VOC) compliant, and more effective paint removal system or composition that more closely matches removal speed of a traditional methylene chloride (MC) containing paint remover compositions.

### SUMMARY OF THE INVENTION

Embodiments of this disclosure provide paint removal or remover compositions including a solvent system or composition and an abrasive system or composition.

Embodiments of this disclosure provide paint removal or remover compositions including a solvent system or composition, an abrasive system or composition, and an additive composition or system.

Embodiments of the this disclosure provide methods of making the paint removal or remover compositions of this disclosure including mixing a solvent composition or system and an abrasive composition or system under conditions of temperature, pressure, time, mixing speed and mixing type to form the abrasive paint removal compositions of this disclosure. In other embodiments, the mixing step or a subsequent mixing step may add an additive composition or system to the remover compositions.

Embodiments of the this disclosure provide methods of using the paint removal or remover compositions of this disclosure including applying a paint removal or remover composition of this disclosure to a painted or coated surface, rubbing the painted or coated surface with the paint removal or remover composition thereon for a rubbing time sufficient to disruption an integrity of the paint or coating and begin to dissolve or lift the paint or coating from the surface, and removing the paint removal or remover composition and paint or coating from the surface to produced a surface having a reduced amount of paint or coating on the surface, a surface having substantially no paint or coating on the surface, or a surface having no paint or coating on the surface. In certain embodiments, the methods may also include the step of after rubbing, allowing the paint removal or remover composition to remain on the painted or coated surface for a soak time sufficient to further dissolve or lift the paint or coating from the surface. In certain embodiments, the methods may also include the steps of after rubbing and prior to the soak step, applying additional paint removal or remover composition to the surface.

### Definitions of Term Used in the Invention

The following definitions are provided in order to aid those skilled in the art in understanding the detailed description of the present invention.

The term “about” means that the value is within about 10% of the indicated value. In certain embodiments, the value is within about 5% of the indicated value. In other embodiments, the value is within about 2.5% of the indicated value. In other embodiments, the value is within about 1% of the indicated value.

The term “substantially” means that the value is within about 5% of the indicated value. In certain embodiments, the value is within about 2.5% of the indicated value. In other embodiments, the value is within about 1% of the indicated value. In other embodiments, the value is within about 0.5% of the indicated value. In other embodiments, the value is within about 0.1% of the indicated value. In other embodiments, the value is within about 0.01% of the indicated value.

The term “regulatory” means OSHA Standard Number 1910.1052 for Occupational Exposure to methylene chloride.

The term “DI” means deionized such as deionized water.

The term “DBE” means dibasic esters of dicarboxylic acids or diesters of dicarboxylic acids.

The term “DMSO” means dimethylsulfoxide.

The term “LVP” means low vapor pressure.

The term “MC” means methylene chloride.

The term “NMP” means n-methyl-2-pyrollidone.

The term “NPE” surfactants mean nonylphenol exthoxylate such as a nonylphenol exthoxylate surfactant, a class of nonionic surfactants.

The term “PCBTF” means parachlorobenzotrifluoride.

The term “OSHA” means United States Department of Labor Occupational Safety and Health Administration.

The terms “n” means normal, “i” means iso, “s” means 2, and “t” mean tert.

The terms “Me” means methyl, “Et” means ethyl, “n-Pr” means normal propyl, “i-Pr” means isopropyl, “n-Bu” means normal butyl, “i-Bu” means isobutyl, “s-Bu” means 2-butyl, and “t-Bu” means tert-butyl.

The term “VOC” means volatile organic compound.

The term “gpt” means gallons per thousand gallons.

The term “ppt” means pounds per thousand gallons.

The term “SRV” means stimulated rock volume.

The term “spf” means shots per foot.

The term “bpm” means barrels per minute.

### DETAILED DESCRIPTION OF THE INVENTION

The inventor has found that a new class of coating or paint remover, removing, or removal compositions may be formulated with or without the use of methylene chloride (MC), where the compositions include a solvent system or composition and an abrasive system or composition. The inventor has found that the solvent systems may be based on a dibasic ester or a mixture of dibasic esters. In other embodiments, the compositions may be mixed with water or a mixture of waters, thickening agent or a mixture of thickening agents, an alcohol amine or a mixture of alcohol amines, an alcohol or a mixture of alcohols, or mixtures or combinations thereof. The compositions are effective in removing painting and other similar coatings from surfaces by applying the compositions, gently rubbing the surface with the composition thereon for a rubbing time, optionally allowing the composition to set on the surface of a soaking time, and removing the composition with the coating or paint to produce a surface having greater than 50% of the paint or coating removed. In certain embodiments, the removal is greater than 75% of the paint or coating. In other embodiments, the removal is greater than 90%. In other embodiments, the removal is greater than 95%. In other embodiments, the removal produces a substantially paint free or coating free surface. In other embodiments, the alcohol additive includes 2-ethyl hexanol. The compositions are well suited for the removal coatings and paint without the use of methylene chloride. In certain embodiments, the abrasive systems or compositions include a functional filler, particularly an abrasive filler, that contains very little, if any, crystalline silica. In other embodiments, the abrasive systems or compositions include hollow fillers to reduce filler packing, reduce product weight and decrease composition cost.

Embodiments of this disclosure broadly relate to paint removal, remover, or removing compositions including a solvent system or composition and an abrasive system or composition. In certain embodiments, the compositions also include an additive system or composition. In certain embodiments, the solvent systems or compositions include at least one (one or a plurality of) DBE. In other embodiments, the solvent systems or compositions may also include at least one (one or a plurality of) hydrocarbon solvent, dimethyl sulfoxide, n-methyl-2-pyrolidone, at least one (one or a plurality of) chlorinated solvent, or mixtures and combinations thereof. In other embodiments, the chlorinated solvents comprise exempt chlorinated solvents. In certain embodiments, the additive systems or compositions may include at least one water, at least one (one or a plurality of) thickening agent, at least one (one or a plurality of) wetting agent or surfactant, at least one (one or a plurality of) ester alcohol, at least one (one or a plurality of) alkanolamine, at least one (one or a plurality of) alcohol, at least one (one or a plurality of) fragrance, or mixtures and combinations thereof.

In one aspect of this disclosure, the compositions are designed to afford a faster way to remove paint with or without the use of methylene chloride (MC) by using designed or tailored remover formulations that may include a non-MC containing solvent system or composition and an abrasive system or composition. Abrading the paint or coating is one way to speed paint/coating removal before and/or during the removal process. The inventor has found that the abrasive system or composition coupled with rubbing of the painted/coated surface after composition application such as with a rag significantly speeds up the paint removal process.

In certain embodiments, the coating or paint remover, removing, or removal compositions are liquids or viscous liquids or pastes. In certain embodiments, the solvent systems or compositions include: (a) a DBE or mixture of DBEs, (b) a combination of a DBE or mixture of DBEs and DMSO, (c) a combination of a DBE or mixture of DBEs and NMP, (d) a combination of a DBE or mixture of DBEs and a mixture of DMSO and NMP, (e) a combination of a DBE or mixture of DBEs and a LVP solvent or a mixture of LVP solvents, (f) a combination of a DBE or mixture of DBEs, DMSO and a LVP solvent or a mixture of LVP solvents, (g) a combination of a DBE or mixture of DBEs, NMP and a LVP solvent or a mixture of LVP solvents, (h) a combination of a DBE or mixture of DBEs, DMSO, NMP, and a LVP solvent or a mixture of LVP solvents, or (i) any of the listed solvent compositions including MC or another chlorinated hydrocarbon solvent. In other embodiments, these specific solvents may include other solvents and may include additives.

In certain embodiments, the liquid coating or paint remover, removing, or removal compositions may include a thickening agent or mixture of thickening agents, where the thickening agents including organic and/or inorganic thickening agents and may be used in a range between 0% and 10%.

In certain embodiments, the liquid coating or paint remover, removing, or removal compositions may include additives to improve performance, where the additives include: (a) alkanolamines to control pH (acting as a weak base), (b) surfactants or wetting agents such as nonylphenol ethoxylates (NPE) nonionic surfactants are typical in these blends with Dow NP-4, NP-6 or NP-9, Dow Ecosurf EH line of low odor, biodegradable surfactants to assist in wetting of the paint surface as well as aiding in water cleanup of the surface after removal of the paint, (c) glycol ethers and ester alcohols to aid in providing improved solvency, reduced drying rates, and improved surface cleaning efficiencies, (d) glycol ethers, (e) ester alcohols, (f) alcohols such as 2-ethylhexanol, and (g) mixtures or combinations thereof. In certain embodiments, these additive are present in a range of about 1% to about 10% based on the non-diluted compositions.

Without being limited by theory, we believe that the abrasive systems improve the overall performance of the remover, while increasing a viscosity of the remover composition. These remover compositions facilitate paint or coating removal via a gentle rubbing the composition on the paint/coating to disrupt the paint/coating and remove the oxidation layer, oil and/or dirt from the paint/coating surface significantly speeding up the paint removal process, especially if the filler is particularly abrasive. In certain embodiments, the abrasive systems include hollow microspheres to reduce the packing of the abrasive agents and improve overall cost of the product. The abrasive remover compositions aid the removal of paint in hard to reach places, such as groves or insets.

### Compositional Ranges Used in the Invention

### Solvents and Abrasives

In certain embodiments of this disclosure, the compositions include:

100 vol. % of a solvent composition or system, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

In certain embodiments of this disclosure, the compositions include:

100 vol. % of a solvent composition or system, and

about 0.01 wt. % to about 75 wt. % of an abrasive composition system and any range between about 0.01 wt. % to about 75 wt. %, where the weight percentages are relative so that amount of abrasive composition is based on 100 vol. % of the solvent system.

In certain embodiments of this disclosure, the compositions include:

100 vol. % of a solvent composition or system, and

about 0.01 wt. % to about 50 wt. % of an abrasive composition system and any range between about 0.01 wt. % to about 50 wt. %, where the weight percentages are relative so that amount of abrasive composition is based on 100 vol. % of the solvent system.

In certain embodiments of this disclosure, the compositions include:

100 vol. % of a solvent composition or system, and

about 0.01 wt. % to about 25 wt. % of an abrasive composition system and any range between about 0.01 wt. % to about 25 wt. %, where the weight percentages are relative so that amount of abrasive composition is based on 100 vol. % of the solvent system.

In certain embodiments of this disclosure, the compositions include:

100 vol. % of a solvent composition or system, and

about 0.01 wt. % to about 10 wt. % of an abrasive composition system and any range between about 0.01 wt. % to about 10 wt. %, where the weight percentages are relative so that amount of abrasive composition is based on 100 vol. % of the solvent system.

### Solvents, Abrasives, and Additives

In other embodiments of this disclosure, the compositions include:

100 vol. % of a solvent composition or system,

about 0.1 wt. % to 100 wt. % of each component of an additive composition or system, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

In other embodiments of this disclosure, the compositions include:

100 vol. % of a solvent composition or system,

about 0.1 wt. % to about 75 wt. % of each component of an additive composition or system and any range therebetween, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

In other embodiments of this disclosure, the compositions include:

100 vol. % of a solvent composition or system,

about 0.1 wt. % to about 50 wt. % of each component of an additive composition or system and any range therebetween, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

In other embodiments of this disclosure, the compositions include:

100 vol. % of a solvent composition or system,

about 0.1% to about 25% of each component of an additive composition or system and any range therebetween, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

In other embodiments of this disclosure, the compositions include:

100 vol. % of a solvent composition or system,

about 0.1% to about 10% of each component of an additive composition or system and any range therebetween, and

about 0.01 wt. % to about 100 wt. % of an abrasive composition system and any range between about 0.01 wt. % to about 100 wt. %, where the weight percentages are relative so that amount of abrasive composition is based on 100 vol. % of the solvent system.

### Specific Solvent Systems

In other embodiments of this disclosure, the solvent compositions or systems include:

100 vol. % of a DBE and a mixture of DBEs.

In other embodiments of this disclosure, the solvent compositions or systems include:

100 vol. % of a DBE and a mixture of DBEs,

0 vol. % to 100 vol. % of a hydrocarbon solvent or a mixture of hydrocarbon solvents,

0 vol. % to 100 vol. % of dimethyl sulfoxide (DMSO),

0 vol. % to 100 vol. % of n-methyl-2-pyrolidone (NMP),

0 vol. % to 100 vol. % of a chlorinated solvent or a mixture of chlorinated solvents, and

0 vol. % to 100 vol. % of a low vapor pressure (LVP) solvent or a mixture of LVP solvents.

In other embodiments of this disclosure, the solvent compositions or systems include:

100 vol. % of a DBE and a mixture of DBEs, and

about 1 vol. % to 100 vol. % of DMSO.

In other embodiments of this disclosure, the solvent compositions or systems include:

100 vol. % of a DBE and a mixture of DBEs, and

about 1 vol. % to 100 vol. % of NMP.

In other embodiments of this disclosure, the solvent compositions or systems include:

100 vol. % of a DBE and a mixture of DBEs

about 1 vol. % to 100 vol. % of DMSO, and

about 1 vol. % to 100 vol. % of NMP.

### Additive Systems

In other embodiments of this disclosure, the additive compositions or systems include:

about 0.1 wt. % to 100 wt. % of a thickening agent or a mixture of thickening agents,

about 0.1 wt. % to 100 wt. % of an alkanolamine or a mixture of alkanolamines for pH control,

about 0.1 wt. % to 100 wt. % of a glycol ether or a mixture of glycol ethers,

about 0.1 wt. % to 100 wt. % of an ester alcohol or a mixture of ester alcohols,

about 0.1 wt. % to 100 wt. % of a water or a mixture of waters,

about 0.1 wt. % to 100 wt. % of an alcohols or a mixture of alcohols, and/or

about 0.1 wt. % to 100 wt. % of a surfactants or a mixture of surfactants.

### Specific Abrasive Systems

In other embodiments, the compositions include between about 0.01 wt. % and about 70 wt. % of an abrasive composition system. In other embodiments, the compositions include between about 0.01 wt. % and about 65 wt. % of an abrasive composition system. In other embodiments, the compositions include between about 0.01 wt. % and about 60 wt. % of an abrasive composition system. In other embodiments, the compositions include between about 0.01 wt. % and about 55 wt. % of an abrasive composition system. In other embodiments, the compositions include between about 0.01 wt. % and about 50 wt. % of an abrasive composition system. In other embodiments, the compositions include between about 0.01 wt. % and about 45 wt. % of an abrasive composition system. In other embodiments, the compositions include between about 0.01 wt. % and about 40 wt. % of an abrasive composition system. In other embodiments, the compositions include between about 0.01 wt. % and about 35 wt. % of an abrasive composition system. In other embodiments, the compositions include between about 0.01 wt. % and about 30 wt. % of an abrasive composition system. In other embodiments, the compositions include between about 0.01 wt. % and about 25 wt. % of an abrasive composition system. In other embodiments, the compositions include between about 0.01 wt. % and about 20 wt. % of an abrasive composition system. In other embodiments, the compositions include between about 0.01 wt. % and about 15 wt. % of an abrasive composition system. In other embodiments, the compositions include between about 0.01 wt. % and about 10 wt. % of an abrasive composition system. In other embodiments, the compositions include between about 0.01 wt. % and about 5 wt. % of an abrasive composition system. In other embodiments, the compositions include between about 0.01 wt. % and about 1 wt. % of an abrasive composition system.

The above percentages may be weight percentages, volume percentages, or mixed volume and weight percentages. The percentages are relative and are based on 100 vol. % of the solvent system.

### Suitable Reagents Used in the Invention

Suitable solvent systems or solvent compositions include, without limitation, a dibasic ester (DBE) or a mixture of dibasic esters (DBEs), a hydrocarbon solvent or a mixture of hydrocarbon solvents, dimethyl sulfoxide (DMSO), n-methyl-2-pyrolidone (NMP), a chlorinated solvent or a mixture of chlorinated solvents, and/or mixtures thereof. In certain embodiments, the solvent systems or the solvent compositions include a DBE or a mixture of DBEs. In certain embodiments, the solvent systems or the solvent compositions include a DBE or a mixture of DBEs and DMSO, NMP and/or at least one LVP solvent.

Suitable DBEs include, without limitation, one or more compounds of the formula ROOC—Z—COOR′, where Z is a hydrocarbyl linking group, a hydrocarbenyl group, or a divalent hydrocarbyl group having between 2 and 20 carbon atoms and R and R′ are the same or different hydrocarbyl groups having between 1 and 6 carbon atoms. In the groups Z, R, and R′, one or more of the carbon atoms may be replaced by an oxygen atom and one or more of the hydrogen atoms may be replaced by a fluorine atom, a chlorine atom, an alkoxy group (OR), or an amide group (CONRR′). Exemplary examples dibasic ester solvents include, without limitation, butanedioic acid (succinic acid) (ROOC—(CH₂)₂—COOR′), pentanedioic acid (glutaric acid) (ROOC—(CH₂)₃—COOR′), hexanedioic acid (adipic acid) (ROOC—(CH₂)₄—COOR′), heptanedioic acid (pimelic acid) (ROOC—(CH₂)₅—COOR′), octanedioic acid (suberic acid) (ROOC—(CH₂)₆—COOR′), nonanedioic acid (azelaic acid) (ROOC—(CH₂)₇—COOR′), decanedioic acid (sebacic acid) (ROOC—(CH₂)₈—COOR′), undecanedioic acid (brassilic acid) (ROOC—(CH₂)₉—COOR′), dodecanedioic acid (ROOC—(CH₂)₁₀—COOR′), hexadecanedioic acid (thapsic acid) (ROOC—(CH₂)₁₁—COOR′), and mixtures or combinations thereof.

In certain embodiments, the Z group has between 2 and 16 carbon atoms and the R and R′ groups are hydrocarbyl groups having between 1 and 3 carbon atoms. In other embodiments, the Z group has between 2 and 14 carbon atoms and the R and R′ groups are hydrocarbyl groups having between 1 and 3 carbon atoms. In other embodiments, the Z group has between 2 and 12 carbon atoms and the R and R′ groups are hydrocarbyl groups having between 1 and 3 carbon atoms. In other embodiments, the Z group has between 2 and 10 carbon atoms and the R and R′ groups are hydrocarbyl groups having between 1 and 3 carbon atoms. In other embodiments, the Z group has between 2 and 8 carbon atoms and the R and R′ groups are hydrocarbyl groups having between 1 and 3 carbon atoms. In other embodiments, the Z group has between 2 and 6 carbon atoms and the R and R′ groups are hydrocarbyl groups having between 1 and 3 carbon atoms. In other embodiments, the Z group has between 2 and 4 carbon atoms and the R and R′ groups are hydrocarbyl groups having between 1 and 3 carbon atoms. In other embodiments, a blend of dimethyl butanedioic acid (succinic acid) (MeOOC—(CH₂)₂—COOMe), pentanedioic acid (glutaric acid) (MeOOC—(CH₂)₃—COOMe), and hexanedioic acid (adipic acid) (MeOOC—(CH₂)₄—COOMe), where Me is methyl.

### Chlorinated Solvents

Suitable chlorinated solvent for use in the compositions of this disclosure include, without limitation, chloromethane, dicloromethane, trichloromethane (chloroform), tetrachloromethane (carbon tetrachloride), chloroethane, dichloroethane, trichloroethane, high chloroethanes, chlorinated ethylenes, higher chlorinated hydrocarbons, or mixtures and combinations thereof.

### Abrasive Materials

Suitable abrasive materials include, without limitation, clays, particulate aluminates, particulate silicates, particulate aluminosilicates, particulate titanates, metal or mixed metal sulfates, metal or mixed metal carbonates, talcs, micas, ceramic spheres, ceramic microspheres, hollow ceramic spheres, hollow ceramic microspheres, polymer spheres, polymer microsphere, hollow polymer spheres, hollow polymer microspheres, solid polymers, particulate natural or synethic zeolites, other particulate metal oxide materials, particulate mixed metal oxides, diatomaceous earth, metal or mixed metal chlorides, metal or mixed metal bromides, ground organic materials, and/or mixtures thereof. Exemplary clays include, without limitation, kaolin clays, bentonite clays, and/or mixtures thereof. Exemplary examples of silicates include, without limitation, silicas, amorphous silicates, aluminum silicates, magnesium silicates, calcium silicates such as wollastonite, and/or mixtures thereof. Exemplary examples of carbonates include, without limitation, calcium carbonates, strontium carbonates, and/or mixtures thereof. Exemplary examples of sulfates include, without limitation, magnesium sulfates, calcium sulfates, barium sulfates, and/or mixtures thereof.

Exemplary examples of ceramic spheres and ceramic microspheres include, without limitation, solid microspheres of products such as 3M Ceramic Microspheres. Exemplary examples of hollow ceramic spheres and hollow ceramic microspheres include, without limitation, Potters Q Cells, Potters Glass Microspheres and/or Fillite™ Ceramic Microspheres. Exemplary examples of organic materials include, without limitation, ground shells such as walnut shells, pecan shells, or other hard shells, ground corn cobs, ground gains, saw dust, ground peat, other ground plant materials, or mixtures and combinations thereof. Surprisingly, we have found that coarser grades of these abrasive agents may be more advantageous in paint removal.

### Additives

Suitable additive systems include, without limitation, a thickening agent or a mixture of thickening agents, a wetting agent or surfactant or a mixture of wetting agents or surfactants, a water or a mixture of waters, an alkanolamine or a mixture of alkanolamines, an alcohol or a mixture of alcohols, a glycol ether or a mixture of glycol ethers, an ester alcohol or a mixture of ester alcohols, a fragrance or a mixture of fragrances, and/or mixtures thereof.

Suitable thickening agents include, without limitation, organic thickening agents, inorganic thickeners, and/or mixtures thereof. Exemplary organic thickening agents include, without limitation, cellulosic thickening agents, Dow Methocel 311 and Tylose PSO81001, modified clay thickening agent, and/or mixtures thereof. Exemplary inorganic thickening agents include, without limitation, BYK Optigel CK Bentonite Clay activate by alcohols, water or other appropriate solvents. ers, where Dow Methocel 311 and Tylose PSO81001 are preferred in this case. In addition, inorganic thickeners may be used such as BYK Optigel CK Bentonite Clay activate by alcohols, water or other appropriate solvents.

Suitable wetting agents or surfactants include, without limitation, a nonionic surfactant or a mixture of nonionic surfactants. Exemplary examples of nonionic surfactants include, without limitation, a nonylphenol ethoxylate (NPE) nonionic surfactant or a mixture of NPE) nonionic surfactants, DOW Ecosurf EH line of low odor, biodegradable surfactants should also work fine.

These surfactants can assist in wetting of the paint surface as well as aiding in water cleanup of the surface after removal of the paint.

Suitable alcohols include, without limitation, linear or branched alcohols having between 6 and 12 carbon atoms, where one or more of the carbon atoms may be replaced by an oxygen atom. In certain embodiments, the alcohol is selected from the group consisting of hexanol, 2-methyl hexanol, 2-ethyl hexanol, heptanol, 2-methyl heptanol, 2 ethyl heptanol, octanol, 2-methyl octanol, 2-ethyl octanol, and mixtures thereof.

Suitable glycol ethers include, without limitation, ethylene glycol monomethyl ether (2-methoxyethanol, CH₃OCH₂CH₂OH), ethylene glycol monoethyl ether (2-ethoxyethanol, CH₃CH₂OCH₂CH₂OH), ethylene glycol monopropyl ether (2-propoxyethanol, CH₃CH₂CH₂OCH₂CH₂OH), ethylene glycol monoisopropyl ether (2-isopropoxyethanol, (CH₃)₂CHOCH₂CH₂OH), ethylene glycol monobutyl ether (2-butoxyethanol, CH₃CH₂CH₂CH₂OCH₂CH₂OH), ethylene glycol monophenyl ether (2-phenoxyethanol, C₆H₅OCH₂CH₂OH), ethylene glycol monobenzyl ether (2-benzyloxyethanol, C₆H₅CH₂OCH₂CH₂OH), diethylene glycol monomethyl ether (2-(2-methoxyethoxy)ethanol, methyl carbitol, CH₃OCH₂CH₂OCH₂CH₂OH), diethylene glycol monoethyl ether (2-(2-ethoxyethoxy)ethanol, carbitol cellosolve, CH₃CH₂OCH₂CH₂OCH₂CH₂OH), diethylene glycol mono-n-butyl ether (2-(2-butoxyethoxy)ethanol, butyl carbitol, CH₃CH₂CH₂CH₂OCH₂CH₂OCH₂CH₂OH), or mixtures thereof. Exemplary examples include, without, limitation, DOW® Cellosolve™ solvents such as DOW® Butyl Cellosolve™ Solvent, the DOW® Carbitol™ solvents such Methyl Carbitol™ Solvent, or mixtures thereof.

Suitable ester alcohols include, without limitation, linear or branched 1-3 diols including at least one linear or branched ester group having between 1 and 6 carbon atoms. Exemplary ester alcohols include 2,2,4-trimethyl-1,3-pentanediol monoisobutyrate, Eastman Texanol™ ester alcohol, or mixtures thereof.

Suitable alkanolamines include, without limitation, methanolamine, ethanolamine, dimethanol amine, diethanolamine, trimethanolamine, triethyanol amine, higher and mixed alkanol amines, where the hydrocarbyl group include 3 to 6 carbon atoms, and mixtures thereof.

Suitable waters include, without limitation, free water, dionized (DI) water, production water, tap water, brines, other aqueous solutions comprising at least 95 wt. % water, or mixtures and combinations thereof.

### EXPERIMENTS OF THE INVENTION

### Example 1

This examples illustrates the preparation of a semi-paste MC free remover.

A 69.2 mL aliquot of RHODIASOLV® RPDE (RHODIASOLV® is a registered trademark of Solvay), a dibasic ester (DBE) solvent system, was added to a 200 mL beaker. The liquid was agitated with an overhead stirrer. 0.9 grams of TYLOSE® PSO 810001 (TYLOSE® is a registered trademark of SE Tylose GmbH & Co. KG), a range of water soluble, non-ionic methyl hydroxyethyl- and methyl hydroxypropyl cellulose, was slowly blended into the DBE solvent system. Then 0.4 mL of DOW® EcoSurf™ EH-9 (DOW® a registered trademark of the Dow Chemical Corporation and EcoSurf™ a trade name of the Dow Chemical Corporation), a nonionic alcohol ethoxylate surfactant, was blended into the mixture. Next, 5 mL of Calumet® LVP 100 (Calumet® is a registered trade mark of Calumet Specialty Products Partners, L.P. now C&A IP Holdings, LLC), a petroleum distillate solvent, was added. 17 mL of DMSO was added slowly with the mixture gelling quickly at this point. 3 mL of Eastman TEXANOL™ (TEXANOL™ is a trade name of Eastman Chemical Company), a 2,2,4-trimethyl-1,3-pentanediol monoisobutyrate ester alcohol solvent, was added, followed by 4.79 mL of PCBTF. Finally, 0.3 mL of a lemon fragrance was added. The Brookfield viscosity of the product was 2640 cP (LV4@60 rpm). This product would be considered a semi-paste MC free remover.

| Amount | Material | Type |
|---|---|---|
| 69.2 mL | DBE | solvent - blend of dibasic esters |
| 0.9 grams | Tylose PSO 810001 | thickening agent |
| 0.4 mL | Dow EcoSurf EH-9 | nonionic surfactant |
| 5 mL | Calumet LVP 100 | aliphatic hydrocarbon solvent |
| 17 mL | DMSO | solvent |
| 3 mL | Eastman Texanol | ester alcohol (C₁₂H₂₄O₃) |
| 4.79 mL | PCBTF | chlorinated solvent |
| 0.3 mL | Lemon Fragrance | additive |
| viscosity | 2640 cP (LV4@60 rpm) | |

### Example 2

This examples illustrates the preparation of another semi-paste MC free remover.

A 1600 mL DME aliquot was put in a gallon blending vessel and agitated with an overhead mixer. Next, 51 grams of TYLOSE® PSO 810001 was slowly added. 10 mL of a Glycol ether EB (Dow Butyl Cellosolve) was added and then 4 mL of DOW® NP-4, a nonylphenol ethoxylate nonionic surfactant. Ethanolamine (20 mL) was added. Finally, 360 mL of 2-ethyl-1-hexanol was added. The mixture was agitated about 10 minutes. A 5.3% masterbatch of Optigel CK (a BYK trade name), a rheology additive based on an activated phyllosilicate (an activated bentonite clay), in DI Water prepared several days before and 200 mL of the mixture added last. The final mixture was agitated about 30 min. The initial Brookfield viscosity was 6850 cP (LV4@3 RPM). This product would be considered a paste remover. The remover was found to thicken more over time, so the amount of thickeners could be reduced, if desired.

| Amount | Material | Type |
|---|---|---|
| 1600 mL | DME aliquot | |
| 51 grams | Tylose PSO 810001 | thickener |
| 10 mL | Glycol ether EB | solvent |
| 4 mL | Dow TERGITOL ™ NP-4 | nonionic surfactant |
| 20 mL | Ethanolamine | additive |
| 360 mL | 2-ethyl-1-hexanol | alcohol |
| 200 mL | 5.3% Optigel CK in DI Water | thickening agent - activated |
| | | bentonite clay product |
| viscosity | 6850 cP (LV4@3 RPM) | |

### Example 3

This examples illustrates the preparation of another semi-paste MC free remover.

The formula from Example 1 was used for this preparation with 80 mL placed in a 150 mL beaker and agitated with an overhead mixer. Next, 25 grams of Nepheline Syenite (Unimin MINEX® 1G-56, where MINEX® is a registered trademark of the Cary Company) was slowly blended into the remover. The final viscosity was greater than 3000 cP (LV4@60 RPM).

| Amount | Material | Type |
|---|---|---|
| 80 mL | Example 1 | removal composition |
| 25 grams | Unimin | abrasive agent - Nepheline Syenite |
| | MINEX ® IG-56 | (silica deficient, sodium- |
| | | potassium alumina silicate) |
| viscosity | 3000 cP (LV4@60 RPM) | |

### Example 4

This examples illustrates the preparation of another semi-paste MC free remover.

The same procedure was used as in Example 4 with 90 mL of Example 1 remover blended with 30 grams of Imerys XCS CARB 120 Calcium Carbonate. The viscosity was greater than 3000 cP (LV4@60 RPM).

| Amount | Material | Type |
|---|---|---|
| 90 mL | Example 1 | removal composition |
| 30 grams | Imerys XCS CARB 120 | abrasive agent-calcium carbonate |
| viscosity | 3000 cP (LV4@60 RPM) | |

Sherwin Williams All Surface Enamel Oil Base Gloss Black Paint was applied to Aluminum Q-Panels in a 3-4 mil coat thickness and aged in a 120 F oven for at least a week. Several mL of each of Example 1, Example 3 and Example 4 removers were applied with some light rubbing. The Example 3 remover took >95% of the paint off of the surface in less than 7 minutes. The Example 4 remover took about 30 minutes to remove the same amount of paint. Finally, the Example 1 remover took 36 minutes to remove >95% of the paint.

TABLE 1
Oil Based Paint Removal Data

| Composition | Amount | Time | % Removal |
|---|---|---|---|
| Ex. 1 | 3 mL | 36 minutes | >95% |
| Ex. 3 | 3 mL | 7 minutes | >95% |
| Ex. 4 | 3 mL | 30 minutes | >95% |

### Example 5

This examples illustrates the preparation of another semi-paste MC free remover.

The same procedure as Example 3 was used to introduce 20 grams of Tolsa Fillite 500.1.1 hollow ceramic microspheres. The product Brookfield Viscosity was 4750 cP (LV4@60 RPM).

| Amount | Material | Type |
|---|---|---|
| 80 mL | Example 3 | removal composition |
| 20 grams | Tolsa Fillite 500.1.1 | abrasive agent-hollow |
| | | ceramic microspheres |
| viscosity | 4750 cP (LV4@60 RPM) | |

### Example 6

This examples illustrates the preparation of another semi-paste MC free remover.

The same procedure as Example 3 was used to introduce 30 grams of Imerys Nyad M 200 Calcium Silicate to the remover base formula to give a Brookfield Viscosity of 4200 cP (LV4@60 RPM).

| Amount | Material | Type |
|---|---|---|
| 80 mL | Example 3 | removal composition |
| 30 grams | Imerys NYAD ® M200 | abrasive agent-wollatonite |
| | | natural calcium silicate |
| viscosity | 4200 cP (LV4@60 RPM) | |

The painted samples on Aluminum panels were prepared as above. About 3 mL of each remover was rubbed on the painted surface and 6 mL additional remover was added. The fastest of the removers tested was Example 5 with 99% removed in less than 18 minutes. The Example 3 remover took off about 65% of the paint in 30 minutes, Example 4 at 75%, Example 6 at 85%. The Example 1 remover took about 70%. The Example 5 product made the paint much easier to remove. These results are tabulated in Table 2.

TABLE 2
Oil Based Paint Removal Data

| Composition | Amount | Time | % Removal |
|---|---|---|---|
| Ex. 1 | 3 mL^{a} + 6 mL^{b} | | 70% |
| Ex. 3 | 3 mL^{a} + 6 mL^{b} | 30 minutes | 65% |
| Ex. 4 | 3 mL^{a} + 6 mL^{b} | | 75% |
| Ex. 5 | 3 mL^{a} + 6 mL^{b} | 18 minutes | 99% |
| Ex. 6 | 3 mL^{a} + 6 mL^{b} | | 85% |

### Example 7

This examples illustrates the preparation of another semi-paste MC free remover.

Used the same procedure as Example 3 to add 6.15 grams of J. Rettenmaier Solthix St52. The product thickened well with a Brookfield Viscosity of 8300 cP (LV4@60 RPM).

| Amount | Material | Type |
|---|---|---|
| 80 mL | Example 3 | removal composition |
| 6.15 grams | Lubrizol Solthix ® St52 | active polymeric water-based |
| | | thickener |
| viscosity | 8300 cP (LV4@60 RPM) | |

### Example 8

This examples illustrates the preparation of another semi-paste MC free remover.

Used the same procedure as Example 3 to introduce 4 grams of Al2Chem ALFS-200 Hydrophilic Fumed Silica. The product was hazy at first, but eventually cleared. The Brookfield Viscosity was 9180 cP (LV4@60 RPM).

| Amount | Material | Type |
|---|---|---|
| 80 mL | Example 3 | removal composition |
| 4 grams | Al2Chem AL FS-200 | abrasive agent-hydrophilic |
| | | fumed silica |
| viscosity | 9180 cP (LV4@60 RPM) | |

### Example 9

This examples illustrates the preparation of another semi-paste MC free remover.

Used the same procedure as Example 3 to introduce 20 grams of Imerys Kaopolite XDA into the remover with a final Brookfield viscosity of 5500 cP (LV4@60 RPM).

| Amount | Material | Type |
|---|---|---|
| 80 mL | Example 3 | removal composition |
| 20 grams | Imerys Kaopolite ™ XDA | abrasive agent-hydrous |
| | | aluminum silicate |
| viscosity | 5500 cP (LV4@60 RPM) | |

### Example 10

This examples illustrates the preparation of another semi-paste MC free remover.

Used the same procedure as Example 3 to introduce 2.65 grams of Potters Q Sheres Q Cell 6014 into 90 mL of the remover. The product had a Brookfield Viscosity of 7250 cP (LV4@60 RPM).

| Amount | Material | Type |
|---|---|---|
| 90 mL | Example 3 | removal composition |
| 2.65 grams | Potters Q CEL ® 6014 | abrasive agent-hollow |
| | | inorganic (glass) microspheres |
| viscosity | 7250 cP (LV4@60 RPM). | |

Examples 7-10 all removed the oil based paint at >99% in less than 30 minutes with the Solthix and Q Cells containing removers appearing slightly better as shown in Table 3.

TABLE 3
Oil Based Paint Removal Data

| Composition | Amount | Time | % Removal |
|---|---|---|---|
| Ex. 7 | 3 mL | <30 minutes | >99% |
| Ex. 8 | 3 mL | <30 minutes | >99% |
| Ex. 9 | 3 mL | <30 minutes | >99% |
| Ex. 10 | 3 mL | <30 minutes | >99% |

### Example 11

This examples illustrates the preparation of another semi-paste MC free remover.

Used the same procedure as Example 3 to introduce 30 grams of Imerys Kaopolite 1168 into 90 mL of remover to produce a creamy product with a Brookfield Viscosity of 7450 cP (LV4@60 RPM).

| Amount | Material | Type |
|---|---|---|
| 90 mL | Example 3 | removal composition |
| 30 grams | Imerys Kaopolite 1168 | abrasive agent-anhydrous |
| | | aluminum silicate |
| viscosity | 7450 cP (LV4@60 RPM) | |

### Example 12

This examples illustrates the preparation of another semi-paste MC free remover.

Used the same procedure as Example 3 to introduce 30 grams of Potters Glass Microspheres 110P8CP01 to achieve a final viscosity of 5230 cP (LV4@60 RPM).

| Amount | Material | Type |
|---|---|---|
| 90 mL | Example 3 | removal composition |
| 30 grams | Potters Sphericel ® 110P8CP01 | abrasive agent-glass |
| | | microspheres |
| viscosity | 5230 cP (LV4@60 RPM). | |

### Example 13

This examples illustrates the preparation of another semi-paste MC free remover.

Used the same procedure as Example 3 to introduce 40 grams of Huber Hubercarb Q200 into produce a final viscosity of 4280 cP (LV4@60 RPM).

| Amount | Material | Type |
|---|---|---|
| 90 mL | Example 3 | removal composition |
| 40 grams | Huber HUBERCARB ® Q200 | abrasive agent-calcium |
| | | carbonate |
| viscosity | 4280 cP (LV4@60 RPM) | |

### Example 14

This examples illustrates the preparation of another semi-paste MC free remover.

Used the same procedure as Example 3 to introduce 40 grams of Huber Huberbrite B-10 barium sulfate into 90 mL of remover. The final viscosity was 3650 cP (LV4@60 RPM).

| Amount | Material | Type |
|---|---|---|
| 90 mL | Example 3 | removal composition |
| 40 grams | Huber HUBERBRITE ® HB 10 | abrasive agent-barium |
| | | sulfate |
| viscosity | 3650 cP (LV4@60 RPM) | |

The removers were tested with 3 mL rubbed over the surface for 30 seconds and 9 mL brushed onto the surface and rubbed and then left to soak for 25 minutes or 30 minutes. The Example 1 remover took 40% of the paint off the surface after 25 minutes. Example 11 remover took 93% of the paint, Example 12 took 90%, Example 13 took 92% and Example 14 took 97%. These results are tabulated in Table 4.

TABLE 4
Oil Based Paint Removal Data

| Composition | Amount | Time | % Removal |
|---|---|---|---|
| Ex. 1 | 3 mL^{a} + 9 mL^{b} | 30 seconds^{c} + 25 minutes^{d} | 40% |
| Ex. 11 | 3 mL^{a} + 9 mL^{b} | 30 seconds^{c} + 30 minutes^{d} | 93% |
| Ex. 12 | 3 mL^{a} + 9 mL^{b} | 30 seconds^{c} + 30 minutes^{d} | 90% |
| Ex. 13 | 3 mL^{a} + 9 mL^{b} | 30 seconds^{c} + 30 minutes^{d} | 97% |

^{a}is the first application amount,
^{b}is the second application amount,
^{c}is rub time, and
^{d}the soak time

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. An abrasive paint remover composition comprising:
a solvent system, and
an abrasive system.

2. The composition of claim 1, further comprising:
100 vol. % of the solvent system, and
include between about 0.01 wt. % and about 100 wt. % of the abrasive composition system.

3. The composition of claim 2, wherein the compositions includes between about 0.01 wt. % and about 90 wt. % of the abrasive composition system, between about 0.01 wt. % and about 80 wt. % of the abrasive composition system, between about 0.01 wt. % and about 70 wt. % of the abrasive composition system, between about 0.01 wt. % and about 60 wt. % of the abrasive composition system, between about 0.01 wt. % and about 50 wt. % of the abrasive composition system, between about 0.01 wt. % and about 40 wt. % of the abrasive composition system between about 0.01 wt. % and about 30 wt. % of the abrasive composition system, between about 0.01 wt. % and about 20 wt. % of the abrasive composition system, between about 0.01 wt. % and about 10 wt. % of the abrasive composition system, between about 0.01 wt. % and about 5 wt. % of the abrasive composition system, or between about 0.01 wt. % and about 1 wt. % of the abrasive composition system.

4. The composition of claim 1, further comprising:
an additive system.

5. The composition of claim 4, further comprising:
about 1 wt. % to 100 wt. % of the additive system.

6. The composition of claim 1, wherein the solvent system includes:
100 vol. % of a dibasic ester (DBE) and a mixture of DBEs, and
0 vol. % to 100 vol. % of a hydrocarbon solvent or a mixture of hydrocarbon solvents,
0 vol. % to 100 vol. % of dimethyl sulfoxide (DMSO),
0 vol. % to 100 vol. % of n-methyl-2-pyrolidone (NMP),
0 vol. % to 100 vol. % of a chlorinated solvent or a mixture of chlorinated solvents, and/or
0 vol. % to 100 vol. % of a low vapor pressure (LVP) solvent or a mixture of LVP solvents.

7. The composition of claim 1, wherein the solvent system includes:
100 vol. % of a dibasic ester (DBE) and a mixture of DBEs, and
about 1 vol. % to 100% of a hydrocarbon solvent or a mixture of hydrocarbon solvents,
about 1 vol. % to 100 vol. % of dimethyl sulfoxide (DMSO),
about 1 vol. % to 100 vol. % of n-methyl-2-pyrolidone (NMP),
about 1 vol. % to 100 vol. % of a chlorinated solvent or a mixture of chlorinated solvents, and/or
about 1 vol. % to 100 vol. % of a low vapor pressure (LVP) solvent or a mixture of LVP solvents.

8. The composition of claim 1, the solvent system include:
100 vol. % of a DBE and a mixture of DBEs, and
about 1 vol. % to 100 vol. % of DMSO.

9. The composition of claim 8, the solvent system include:
about 1 vol. % to 100 vol. % of NMP.

10. The composition of claim 9, the solvent system include:
about 1 vol. % to 100% of a LVP solvent or a mixture of LVP solvents.

11. The composition of claim 4, wherein the additive system includes:
about 1 wt. % to 100 wt. % of a thickening agent or a mixture of thickening agents,
about 1 wt. % to 100 wt. % of an alkanolamine or a mixture of alkanolamines for pH control,
about 1 wt. % to 100 wt. % of a glycol ether or a mixture of glycol ethers,
about 1 wt. % to 100 wt. % of an ester alcohol or a mixture of ester alcohols,
about 1 wt. % to 100 wt. % of a water or a mixture of waters,
about 1 wt. % to 100 wt. % of an alcohols or a mixture of alcohols, and/or
about 1 wt. % to 100 wt. % of a surfactants or a mixture of surfactants.

12. A method of removing paint comprising:
applying, to a surface including at least one paint and/or coating layer, an initial amount of an abrasive paint remover composition comprising:
a solvent system, and
an abrasive system,
where the initial amount of the composition is sufficient to coat the surface with the composition,
rubbing the initial amount of the composition on the painted/coated surface to improve composition penetration into the paint and/or coating, and
removing the composition and the paint and/coating from the surface,
where the solvent system includes no methylene chloride.

13. The method of claim 12, wherein the rubbing is for a rubbing time between 1 second and 5 minutes.

14. The method of claim 12, further comprising:
after the rubbing step and prior to the removing step, soaking the composition into the paint and/or coating on the surface.

15. The method of claim 12, wherein the soaking is for a soak time between 1 minute and 60 minutes.

16. The method of claim 12, further comprising:
after the rubbing step and prior to the removing step, applying an additional amount of the composition to the surface.

17. The method of claim 16, further comprising:
soaking the composition into the paint and/or coating on the surface.

18. The method of claim 17, wherein the soaking is for a soaking time between 1 minute and 60 minutes.

19. The method of claim 12, further comprising:
after the rubbing step and prior, applying an additional amount of the composition to the surface,
second rubbing the initial and additional amounts of the composition on the painted/coated surface to improve composition penetration into the paint and/or coating, and
after the second rubbing step and prior to the removing step, soaking the composition into the paint and/or coating on the surface.

20. The method of claim 19, wherein the soaking is for a soaking time between 1 minute and 60 minutes.
